(19) United States
(12) Patent Application Publication
(10) Pub. No.: US 2011/0047805 A1
(43) Pub. Date: Mar. 3, 2011

(54) Razor blade extender

(76) Inventor: James Michael Deininger, Columbia, MD (US)

(21) Appl. No.: 12/583,939

(22) Filed: Aug. 28, 2009

(51) Int. Cl. B26B 21/60; B24B 1/04

(52) U.S. Cl. 30/346.53; 451/45

(57) ABSTRACT

A system for sharpening and or honing a multi-bladed razor cartridge including a handle and flexible honing material. The flexible honing material is used to hone the razor blades prior to use and to remove excess moisture from the razor blades once the razor blades are cleaned after shaving. The flexible honing material is made of a chamois which can conform to the shape of the razor blade cartridge and razor blades within the cartridge.

### CROSS-REFERENCE TO RELATED APPLICATIONS

Not Applicable.

### FEDERALLY SPONSORED RESEARCH AND DEVELOPMENT

Not Applicable.

### BACKGROUND

1. Field of the Invention

The present invention relates generally to sharpeners for hand held safety razors.

2. Description of Prior Art

Hand held safety razor blades used for shaving hair from the human body generally include a razor cartridge attached to a razor handle. The razor cartridge includes one or more individual blades, with multiple blades being arranged in parallel. Generally the razor blades are capable of a maximum of between five and ten close shaves based on the hair being shaved and the care given to the razor blades. The razor cartridge is then discarded and a new razor cartridge inserted into the handle.

Moisture within the environment causes damage to the razor blades if not removed between use. No protective coating is applied to the razor blades after use to prevent the formation of microscopic rust on the razor blades surface.

Sharpeners for hand held safety razors are known in the prior art. Leather razor strops have been used for decades to hone straight razors. While this has worked on single hand held blades, it was not intended for sharpening multiple blades or a cartridge of blades. In addition the hard leather does not conform to the shape of the razor blades in the razor cartridge, making it difficult to provide the precise angle required to sharpen the razor blades in a multi-bladed razor cartridge. It also does not remove excess moisture from the razor blades after shaving is completed or coat the razor blades to reduce or prevent the formation of rust on the razor blades.

A hand operated sharpener is disclosed in U.S. Pat. No. 5,036,731, the disclosure of which is incorporated by reference in its entirety. Although effective, it requires stoking the razor blade at a precise angle to properly sharpen the razor blade. It also does not remove excess moisture from the razor blades after shaving is completed or coat the razor blades to reduce or prevent the formation of rust on the razor blades.

An automated sharpener is disclosed in U.S. Pat. No. 6,506,106, the disclosure of which is incorporated by reference in its entirety. While this automated process presents a significant advance over the manual sharpener, the basic sharpening method is essentially the same for both the manual and automated method. In addition, the motorized portion of the automated sharpener makes the overall device somewhat bulky, generally larger, and possibly more expensive than necessary. It also does not remove excess moisture from the razor blades after shaving is completed or coat the razor blades to reduce or prevent the formation of rust on the razor blades.

A manual sharpener with aloe vera gel lubricant is disclosed in U.S. Pat. No. 7,553,218, the disclosure of which is incorporated by reference, in its entirety. While this apparatus for sharpening uses a mirrored plate glass to sharpen with a holder to achieve the precise angle required to sharpen the razor blades, the surface does not easily conform to the razor blades. It also does not remove excess moisture from the blades after shaving is completed or coat the blades to reduce or prevent the formation of rust on the razor blades.

The prior art discloses examples of apparatus for sharpening blades of a razor, but none providing the combination of features disclosed and claimed herein.

### SUMMARY

In accordance with the present invention, there is provided a system to hone the razor blades of a multi-bladed razor cartridge and to prevent rust from forming on the razor blades between uses.

### OBJECTS AND ADVANTAGES

Accordingly, there are several objects and advantages of my invention. First, the angle at which the handle of the razor handle may be honed is not critical since the flexible honing material conforms to the surface of the razor blades in the cartridge. The flexible honing material presses directly against the razor blades at a variety of angles of the razor handle conforming to the razor blades and spaces between the razor blades. A further advance is that moisture can be removed from the razor blades after shaving and transferred to the flexible honing material reducing the formation of microscopic rust on the razor blades. A further advance is that a coat of oil is transferred from the flexible honing material to the razor blades to reduce or prevent the formation of rust on the razor blades between use.

Further objects and advantages of my invention will become apparent from a consideration of the drawings and ensuing description.

### DRAWING FIGURES

FIG. 1 is a perspective view of the razor blade extender showing the separate handle, honing material and assembled razor blade extender.

FIG. 2 is a front and side view of the razor blade extender.

FIG. 3 is a perspective view showing the razor being pushed against the flexible honing material.

FIG. 4 is a side view of the razor being pushed against the flexible honing material.

FIG. 5 is an expanded view of the razor blade cartridge being pushed against the flexible honing material.

### REFERENCE NUMERALS IN DRAWINGS

10 handle
12 mounting hole
14 flexible honing material
16 seam joining flexible honing material
18 razor handle
20 razor cartridge
22 razor blades

### DESCRIPTION

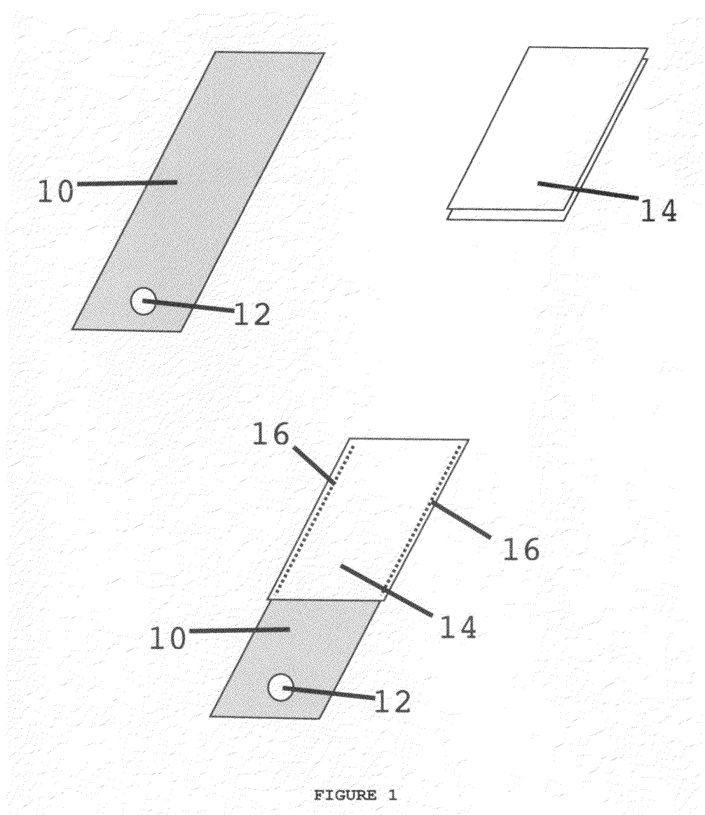

FIG. 1 shows the razor blade extender consists of a handle 10 which includes a hole 12 to allow the razor blade extender 10 to be hung on a nail or hook. A flexible honing material 14 which is folded in half and sewn with a seam joining the homing material 16 on two sides to form a pocket. The handle 10 is then inserted into the pocket formed by the flexible honing material 14. The flexible honing material is loosely fitted over the handle which allows it to conform to the razor blade head. In the preferred embodiment the flexible honing material 14 consists of a chamois made of goat skin which has a small amount of oil added to the chamois to help coat the razor blades 22 with oil.

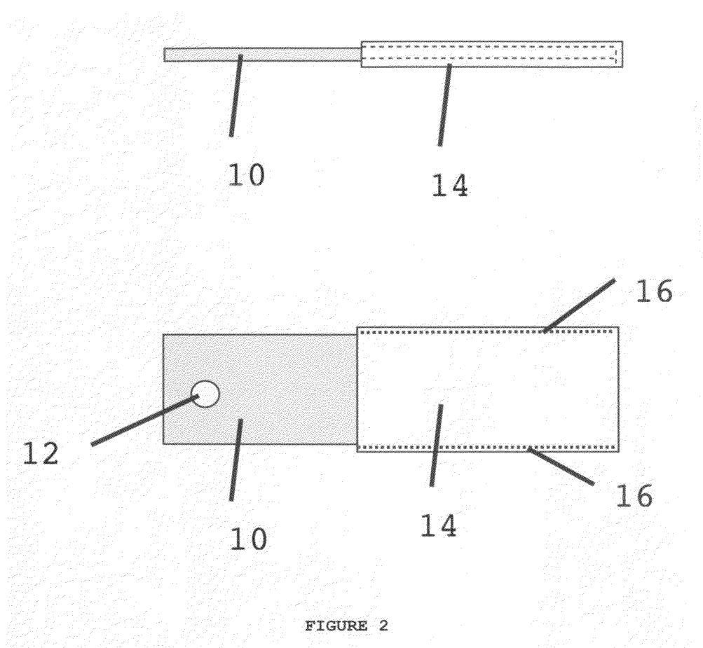

FIG. 2 shows the razor blade extender in a front and side view with the handle 10 inserted in the flexible honing material 14.

### OPERATION

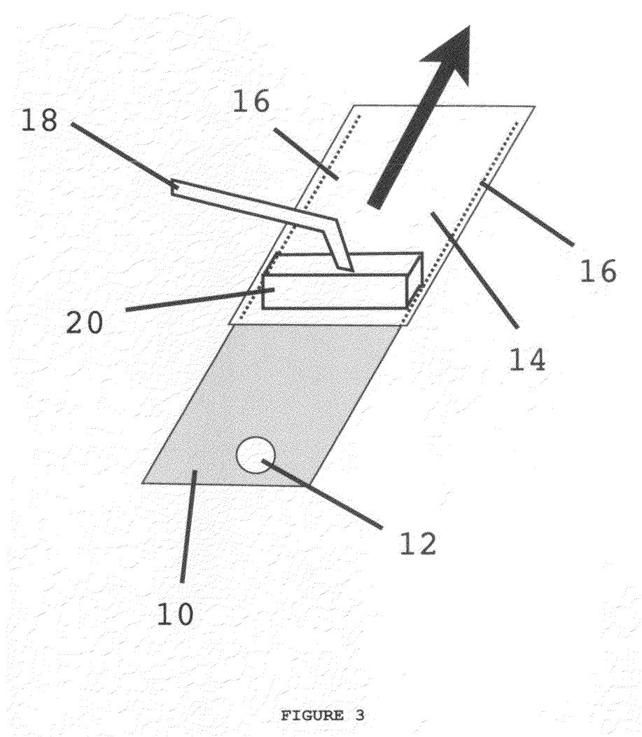

As shown in FIG. 3 the razor blade extender is held with one hand or placed on a flat service. The razor cartridge 20 is then stroked using the razor handle 18 in one direction against the flexible honing material 14 to hone the razor blades 22.

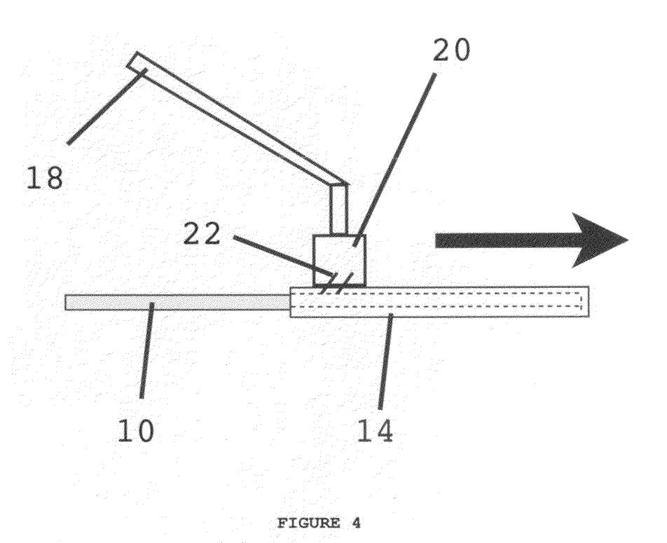

FIG. 4 shows a side view of the razor blade extender in operation. The razor blade cartridge 20 is stroked using the razor handle 18 against the flexible honing material 14 in one direction to hone the razor blades 22.

The flexible honing material 14, being a soft material loosely fitted over the handle 10 conforms to the razor blade cartridge 20 and allows the razor blades 22 to push against the flexible honing material 14. This action aligns the edge of the razor blades 22 which produces a cleaner shave when used.

The razor blades 22 are passed repeatedly over the flexible honing material 14 five to ten times to hone the razor blades 22. The razor is then used to shave.

Once the razor has finished being used to shave, it is rinsed, dried, then the razor blade is again passed repeatedly over the flexible honing material 14 five to ten times to remove any remaining moisture on the razor blades 22. This also has the effect of transferring a small amount of oil present in the flexible honing material 14 to the surface of the razor blades 22 which helps to coat the razor blades 22 and prevent rust from forming between use of the razor.

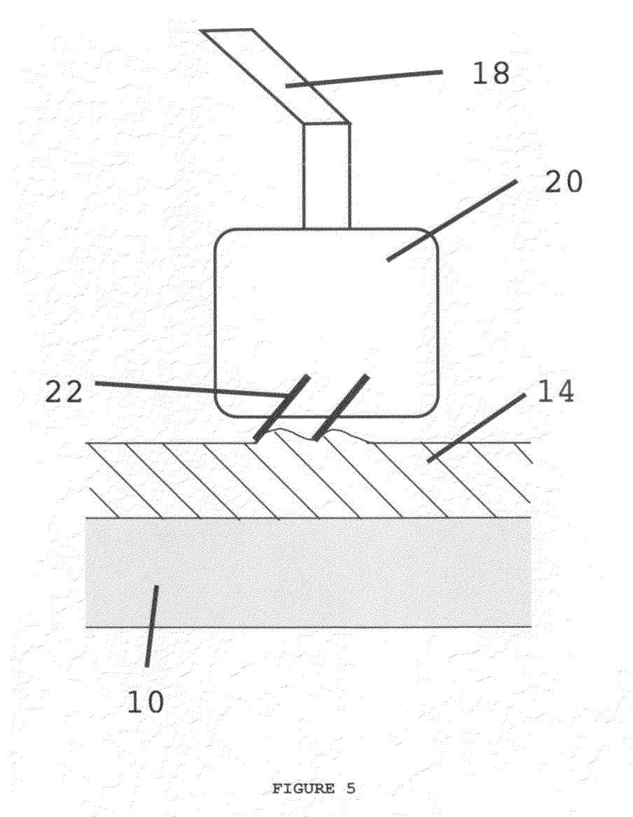

FIG. 5 is an expanded view of the razor blades 22 being stroked against the flexible honing material 14. It illustrates how the flexible honing material 14 conforms to the razor blades 22 to hone the razor blades 22, to remove excess moisture from the razor blades 22 and to transfer oil from the flexible honing material 14 to the razor blades 22 to coat the razor blades 22 between use thereby preventing microscopic rust from forming on the razor blades 22.

### CONCLUSION, RAMIFICATIONS, AND SCOPE

Thus the reader will see that the razor blade extender allows the razor blades 22 to easily and quickly be honed before each shave to help realign the razor blades 22 edge. It also removes excess water after the razor blades 22 are cleaned after use and deposits a small amount of oil from the flexible honing material 14 onto the razor blades 22 to protect the razor blades 22 from the formation of rust between use.

While my above description contains many specificities, there should not be construed as limitations on the scope of the invention, but rather as an exemplification of one preferred embodiment thereof. Many other variations are possible. For example, the width of the handle 10 and flexible honing material 14 can be made narrower to more easily conform to the razor blades 22 so the razor blade cartridge 20 does not stand off from the flexible honing material 14.

Accordingly, the scope of the invention should be determined not by the embodiment illustrated, but by the appended claims and their legal equivalents.

I claim:

1. A method for extending the life of a razor blade cartridge consisting of:
a) means for honing razor blades in a razor cartridge consisting of a flexible honing material; and
b) means for supporting said flexible honing material consisting of a handle on which the flexible honing material is attached whereby a razor blade may be honed to sharpen the razor blades before use, to remove excess moisture from the razor blades after use, and to deposit a protective coat of oil on the razor blades to prevent the formation of rust on the razor blades between use.

2. The method of claim 1 further including a means for removing excess moisture from razor blades in a razor cartridge after rinsing said razor blades.

3. The method of claim 1 further including a means for adding a protective coat of oil to the razor blades in a razor cartridge to protect the razor blades from the formation of rust on said razor blades between use.

4. The method of claim 1 further including a means to hang or secure said handle to a wall consisting of a hole in the handle.

5. The method of claim 1 further including a chamois as said flexible honing material.

6. A apparatus for extending the life of a razor blade cartridge consisting of:
a) a flexible honing material; and
b) a handle on which the flexible honing material is attached whereby a razor blade may be honed to sharpen the razor blades before use, to remove excess moisture from the razor blades after use, and to deposit a protective coat of oil on the razor blades to prevent the formation of rust on the razor blades between use.

7. The apparatus of claim 6 further including a hole in said handle to hang or secure said handle to a wall.

8. The apparatus of claim 6 further including a chamois as said flexible honing material.
